(19) United States
(12) Patent Application Publication
(10) Pub. No.: US 2026/0370811 A1
(43) Pub. Date: Nov. 19, 2026

(54) LOW COMPLEXITY MOTION REFINEMENT

(71) Applicant: InterDigital CE Patent Holdings, SAS, Paris (FR)

(72) Inventors: Franck GALPIN, Thorigne-Fouillard (FR); Philippe BORDES, LAILLE (FR); Antoine ROBERT, Mézières sur Couesnon (FR); Hassane GUERMOUD, THORIGNE FOUILLARD (FR)

(21) Appl. No.: 19/121,835

(22) PCT Filed: Oct. 19, 2023
(86) PCT No.: PCT/EP2023/079162

§ 371 Date: Apr. 17, 2025

(30) Foreign Application Priority Data
Oct. 21, 2022 (EP) 22306603.6

(51) Int. Cl. H04N 19/107; H04N 19/137; H04N 19/17

(52) U.S. Cl. CPC H04N 19/107; H04N 19/137; H04N 19/17

(57) ABSTRACT

In one implementation, the search of the motion vector offset on the motion model parameters, for example, CPMVs in an affine motion model, is simplified. In particular, only initial motion compensation is performed based on the initial CPMVs, and motion-compensated prediction with motion offset is approximated by using a method similar to PROF. For a sample in a block, a motion vector difference can be obtained based on the initial CPMVs and the adjusted CPMVs. Then based on the motion vector difference and the spatial gradients in the prediction, the sample luminance value can be refined. Such motion refinement can also be performed by modifying the affine model parameters, or when the initial motion model is not affine.

### TECHNICAL FIELD

The present embodiments generally relate to a method and an apparatus for bi-prediction in video encoding and decoding.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

According to an embodiment, a method of video encoding is presented, comprising: obtaining a first set of motion vectors for a plurality of samples in a region of a picture; obtaining a first prediction for said region based on said first set of motion vectors for said region; obtaining a second set of motion vectors for said plurality of samples in said region; forming a second prediction for said region based on said first prediction; adjusting said second prediction for said region based on optical flow, using at least a motion difference between said first set of motion vectors and said second set of motion vectors and using spatial gradients of said plurality of samples in said region; selecting a prediction from at least said first prediction and second prediction; and encoding said region based on said selected prediction.

According to another embodiment, a method of video decoding is presented, comprising: obtaining a first set of motion vectors for a plurality of samples in a region of a picture; obtaining a first prediction for said region based on said first set of motion vectors for said region; obtaining a second set of motion vectors for said plurality of samples in said region; forming a second prediction for said region based on said first prediction; adjusting said second prediction for said region based on optical flow, using at least a motion difference between said first set of motion vectors and said second set of motion vectors and using spatial gradients of said plurality of samples in said region; selecting a prediction from at least said first prediction and second prediction; and decoding said region based on said selected prediction.

According to another embodiment, an apparatus for video encoding is presented, comprising at least a memory and one or more processors, wherein said one or more processors are configured to: obtain a first set of motion vectors for a plurality of samples in a region of a picture; obtain a first prediction for said region based on said first set of motion vectors for said region; obtain a second set of motion vectors for said plurality of samples in said region; form a second prediction for said region based on said first prediction; adjust said second prediction for said region based on optical flow, using at least a motion difference between said first set of motion vectors and said second set of motion vectors and using spatial gradients of said plurality of samples in said region; select a prediction from at least said first prediction and second prediction; and encode said region based on said selected prediction.

According to another embodiment, an apparatus for video decoding is presented, comprising at least a memory and one or more processors, wherein said one or more processors are configured to: obtain a first set of motion vectors for a plurality of samples in a region of a picture; obtain a first prediction for said region based on said first set of motion vectors for said region; obtain a second set of motion vectors for said plurality of samples in said region; form a second prediction for said region based on said first prediction; adjust said second prediction for said region based on optical flow, using at least a motion difference between said first set of motion vectors and said second set of motion vectors and using spatial gradients of said plurality of samples in said region; select a prediction from at least said first prediction and second prediction; and decode said region based on said selected prediction.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for encoding or decoding a video according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4A and FIG. 4B illustrate control point motion vectors used in a 4-parameter affine model and a 6-parameter affine model, respectively.

FIG. 5 illustrates the affine MVF (Motion Vector Field) for sub-blocks.

FIG. 6 illustrates the optical flow trajectory.

FIG. 7 illustrates an extended CU region used in BDOF.

FIG. 8 illustrates decoder side motion vector refinement (DMVR).

FIG. 9 illustrates a process of decoder side motion vector refinement.

FIG. 10 illustrates sub-block MV V_{SB} and pixel Δv_{P}(x, y).

FIG. 11 illustrates DMVR with enlarged buffer prediction.

FIG. 12 illustrates an overall process overview of DMVR.

FIG. 13 illustrates the original DMVR process.

FIG. 14A illustrates tested offsets at the first round (integer precision) and FIG. 14B illustrates tested offsets at the second round (half-pel precision)

FIG. 15 illustrates another process of affine model search.

FIG. 16 illustrates a modified process of affine model search, according to an embodiment.

FIG. 17 illustrates an example of sample positions when using different motion offsets for both CPMVs.

FIG. 18 illustrates Δv_{P}(x, y) used in prediction refinement, according to an embodiment.

FIG. 19 illustrates a process to select the best motion from multiple motion candidates, according to an embodiment.

### DETAILED DESCRIPTION

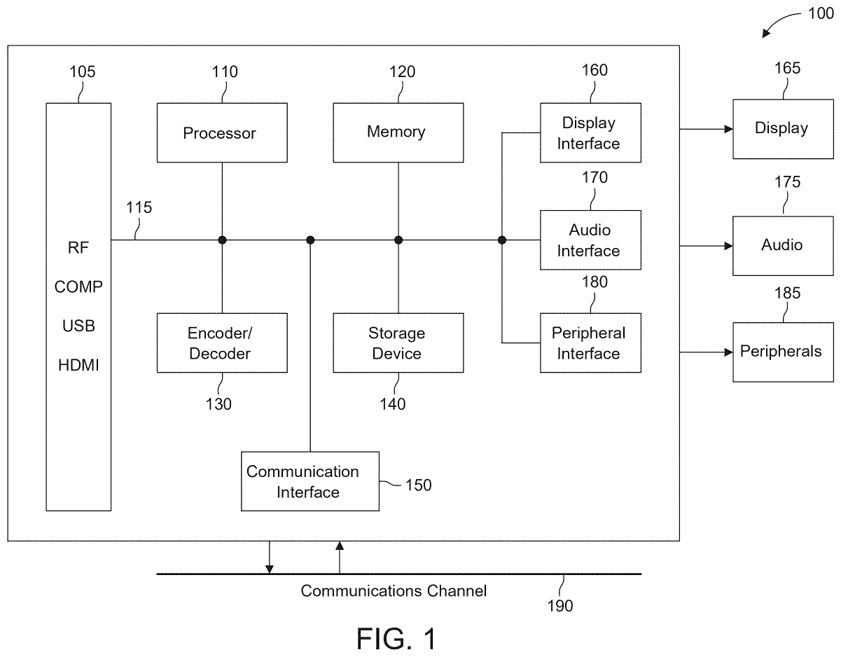

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various in embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface Ics or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

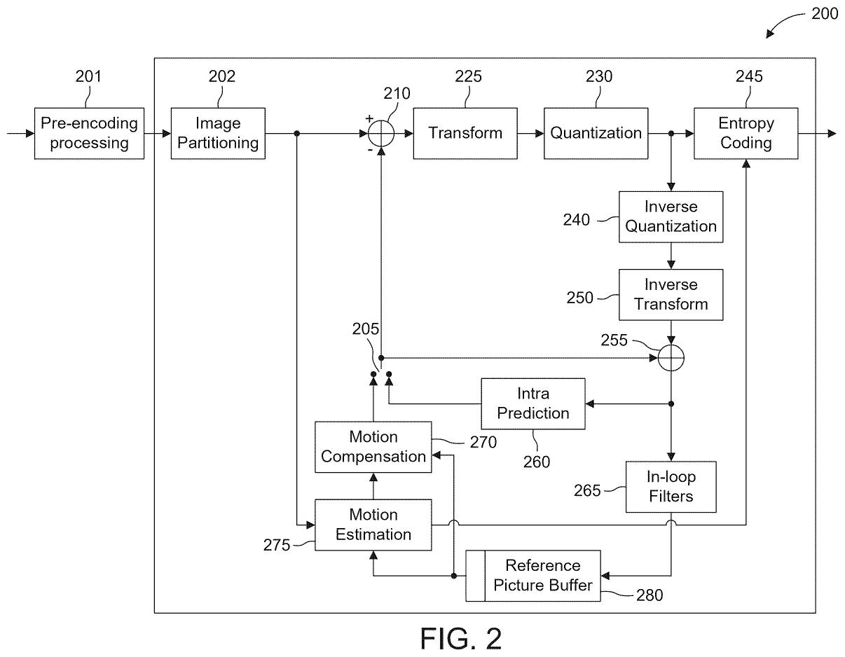

FIG. 2 illustrates an example video encoder 200, such as a a VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YcbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, Cus (Coding Units). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements such as the picture partitioning information, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filter) filtering to reduce encoding artifacts. The filtered image is stored in a reference picture buffer (280).

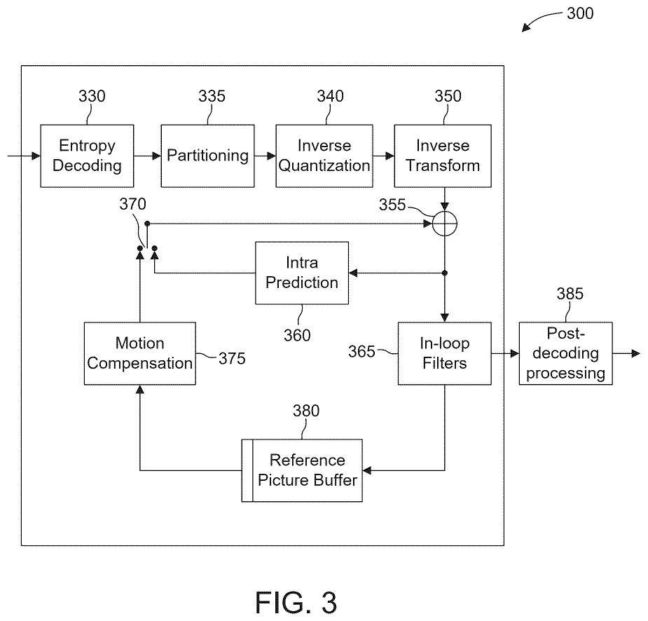

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, prediction modes, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380). Note that, for a given picture, the contents of the reference picture buffer 380 on the decoder 300 side is identical to the contents of the reference picture buffer 280 on the encoder 200 side for the same picture.

The decoded picture can further go through post-decoding processing (385), for example, an inverse color transform (e.g., conversion from YcbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

Bi-prediction is a basic tool used in hybrid video coding. It is built as an average of two uni-predictions, leading to more stable signal prediction, reducing coding artefacts and compensating for consistent temporal illumination change intrinsically.

The Decoder side Motion Vector Refinement (DMVR) technique allows improving the regular bi-prediction technique by reducing the amount of syntax while refining the motion locally. However, the existing DMVR is not compatible with the affine model.

### Affine Motion-Compensated Prediction

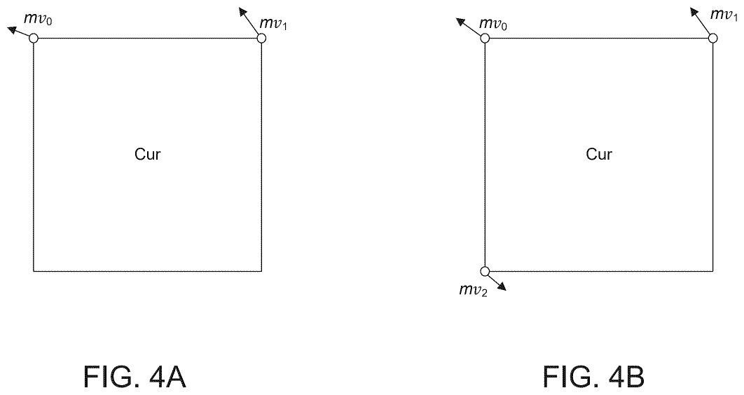

In HEVC, only the translational motion model is applied for motion-compensated prediction (MCP). While in the real world, there are many kinds of motion, e.g., zoom in/out, rotation, perspective motions and other irregular motions. In VVC, a block-based affine motion-compensated prediction is applied. As shown in FIG. 4A and FIG. 4B, the affine motion field of the block is described by motion information of two control point (4-parameter) or three control point motion vectors (6-parameter).

For a 4-parameter affine motion model, the motion vector at sample location (x, y) in a block is derived as:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix}$$

For a 6-parameter affine motion model, the motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix}$$

where (mv₀ₓ, mv_{0y}) is the motion vector of the top-left corner control point, (mv₁ₓ, mv_{1y}) is the motion vector of the top-right corner control point, and (mv₂ₓ, mv_{2y}) is the motion vector of the bottom-left corner control point and (0,0) is the top-left sample coordinate of the block.

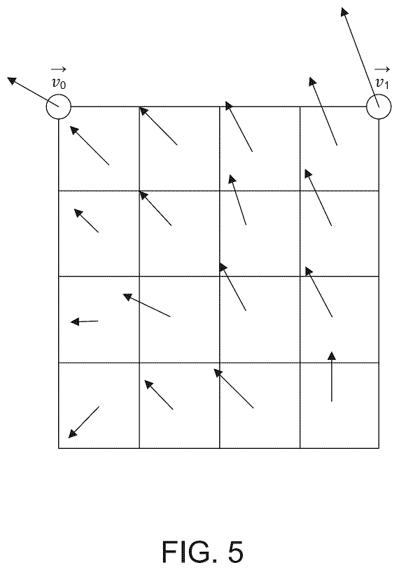

In order to simplify the motion-compensated prediction, block-based affine transform prediction is applied. To derive motion vector of each 4×4 luma subblock, the motion vector of the center sample of each subblock, as shown in FIG. 5, is calculated according to above equations, and rounded to 1/16 fractional-pel accuracy. Then the motion compensation interpolation filters are applied to generate the prediction of each subblock with the derived motion vector. The subblock size of chroma-components is also set to be 4×4. The MV of a 4×4 chroma subblock is calculated as the average of the MVs of the top-left and bottom-right luma subblocks in the collocated 8×8 luma region.

As for translational motion inter prediction, there are also two affine inter prediction modes: affine merge mode and affine AMVP mode.

### Temporal Optical Flow

### Bi-Directional Optical Flow (BDOF)

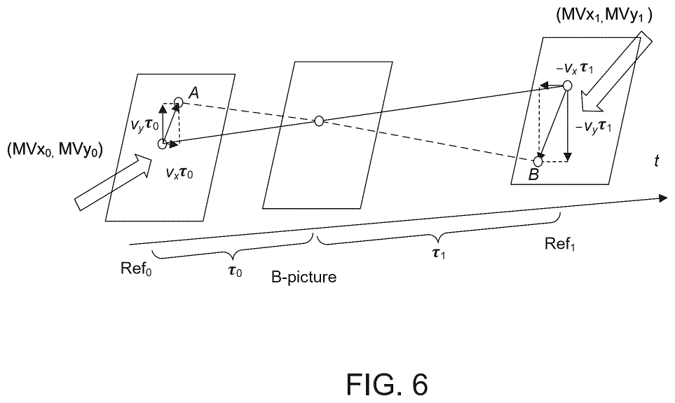

The bi-directional optical flow (BDOF) tool is included in VVC. BDOF, previously referred to as BIO, is used to refine the bi-prediction signal of a CU at the 4×4 sub-block level. As its name indicates, the BDOF mode is based on the optical flow concept, which assumes that the motion of an object is smooth and its luminance is constant along the considered time interval. BDOF is sample-wise motion refinement which is performed on top of block-wise motion compensation for bi-prediction. The sample-level motion refinement doesn't use signaling. In case of bi-prediction, the goal of BDOF is to refine motion for each sample assuming linear displacement in-between the two reference pictures and based on Hermite's interpolation of the optical flow as shown in FIG. 6.

BDOF is applied to a CU if it satisfies the following conditions:
the CU's height is not 4, the CU's width is not 4 and the CU area is larger or equal to 128 (not in ECM (Enhanced Compression Model));
the CU is not coded using affine mode or using the SbTMVP (Sub-block Temporal Motion Vector Prediction) merge mode;
the CU is not coded using the CIIP (Combined Inter-Intra Prediction) merge mode, the MMVD (Merge Mode with Motion Vector Difference) merge mode or the SMVD (Symmetric MVD coding) mode;
BCW (Bi-Prediction with CU-level Weights) weight index indicates equal weight;
In ECM, the CU should not use LIC (Local Illumination Compensation) or OBMC (Overlapped Block Motion Compensation);
the CU is coded using “true” bi-prediction mode (bi-directional mode), i.e., one of the two reference pictures is prior to the current picture in display order and the other is after the current picture in display order. The distances (i.e., POC difference) from two reference pictures to the current picture are the same.
   BDOF is only applied to the luma component.

For each 4×4 sub-block, a motion refinement (v_{xB}, v_{yB}) is calculated by minimizing the difference between the L0 and L1 prediction samples. The motion refinement is then used to adjust the bi-predicted sample values in the 4×4 sub-block. The following steps are applied in the BDOF process.

$$\frac{\partial {I}^{( k )}}{\partial x} ( i , j ) and \frac{\partial {I}^{( k )}}{\partial y} ( i , j ) , k = 0 , 1 ,$$

First, the horizontal and vertical gradients of the two prediction signals are computed by directly calculating the difference between two neighboring samples, i.e.,

$$\frac{\partial {I}^{( k )}}{\partial x} ( i , j ) = ( {I}^{( k )} ( i + 1 , j ) - {I}^{( k )} ( i - 1 , j ) ) ≫ 4$$

$$\frac{\partial {I}^{( k )}}{\partial y} ( i , j ) = ( {I}^{( k )} ( i , j + 1 ) - {I}^{( k )} ( i , j - 1 ) ) ≫ 4$$

### Equation 1: The Horizontal and Vertical Gradients of the Two Prediction Signals.

where I^{(k)}(i, j) is the sample value at coordinate (i, j) of the prediction signal in list k, k=0.1

Then, the auto- and cross-correlation of the gradients, S₁, S₂, S₃, S₅ and S₆, are calculated as

S₁=Σ_{(i,j)∈Ω}ψₓ(i,j)·ψₓ(i,j), S₃=Σ_{(i,j)∈Ω}θ(i,j)·ψₓ(i,j)

S₂=Σ_{(i,j)∈Ω}ψₓ(i,j)·ψₓ(i,j)

S₅=Σ_{(i,j)∈Ω}ψ_{y}(i,j)·ψ_{y}(i,j) S₆=Σ_{(i,j)∈Ω}θ(i,j)·ψ_{y}(i,j)

### Equation 2: The Auto- and Cross-Correlation of the Gradients.

where:

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a}$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a}$$

θ(i,j)=(I⁽¹⁾(i,j)>>n_{b})−(I⁽⁰⁾(i,j)>>n_{b})

where Ω is a 6×6 window surrounding the 4×4 sub-block.

The motion refinement (v_{xB}, v_{yB}) is then derived using the cross- and auto-correlation terms using the following:

$${v}_{xB} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) : 0$$

$${v}_{yB} = {S}_{5} > 0 ? clip 3 ( - {th}_{BIO}^{′} , {th}_{BIO}^{′} , - ( ( {S}_{6} \cdot {2}^{{n}_{b} - {n}_{a}} ( ( {v}_{x} {S}_{2 , m} ) ≪ {n}_{{S}_{2}} + {v}_{x} {S}_{2 , s} ) / 2 ) ≫ ⌊ {log}_{2} {S}_{5} ⌋ ) ) : 0$$

Equation 3: Derive the Motion Vector Refinement (v_{xB}, v_{yB}).
where

$${S}_{2 , m} = {S}_{2} ≫ {n}_{{S}_{2}} , {S}_{2 s} = {S}_{2} \& ( {2}^{{n}_{{S}_{2}}} - 1 ) , {th}_{BIO}^{′} = {2}^{13 - BD} .$$

and └·┘ is the floor function.

Based on the motion refinement and the gradients, the following adjustment is calculated for each sample in the 4×4 sub-block:

$$Δ {I}_{B} ( x , y ) = rnd ( ( {v}_{xB} ( \frac{\partial {I}^{( 1 )} ( x , y )}{\partial x} - \frac{\partial {I}^{( 0 )} ( x , y )}{\partial x} ) ) / 2 ) + rnd ( ( {v}_{yB} ( \frac{\partial {I}^{( 1 )} ( x , y )}{\partial y} - \frac{\partial {I}^{( 0 )} ( x , y )}{\partial y} ) ) / 2 )$$

Equation 4: Adjustment with BDOF for Each Sample in the 4×4 Sub-Block.
where rnd( ) is the round function to return the integral value that is nearest to the argument.

Finally, the BDOF samples of the CU are calculated by adjusting the bi-prediction samples as follows:

I_{B}(x,y)=(I₀(x,y)+I₁(x,y)+ΔI_{B}(x,y)+o_{offset})>>shift

Equation 5: Adjust the Bi-Prediction Samples with BDOF.
where o_{offset} and shift are used to normalize the final predictor to input bitdepth.

In the above, the values of nₐ, n_{b} and n_{S}_{₂} are equal to 3, 6, and 12, respectively. These values are selected such that the multipliers in the BDOF process do not exceed 15-bit, and the maximum bit-width of the intermediate parameters in the BDOF process is kept within 32-bit.

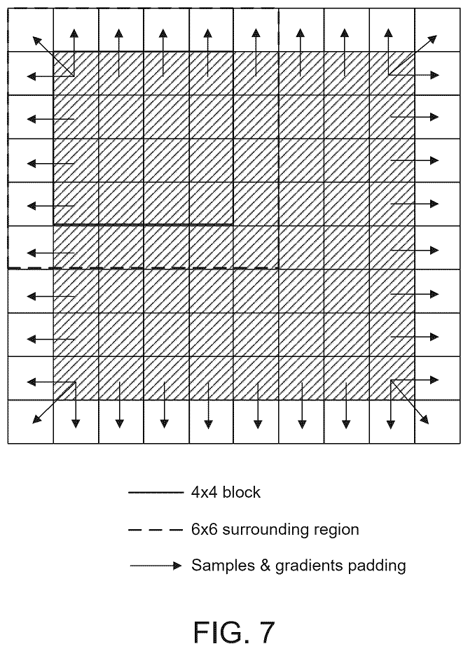

In order to derive the gradient values, some prediction samples I^{(k)}(i, j) in list k (k=0,1) outside of the current CU boundaries need to be generated. As depicted in FIG. 7, the BDOF in VTM-3.0 (VVC Test Model 3.0) uses one extended row/column around the CU's boundaries. In order to control the computational complexity of generating the out-of-boundary prediction samples, a bilinear filter is used to generate prediction samples in the extended area (white positions), and the normal 8-tap motion compensation interpolation filter is used to generate prediction samples within the CU (hatched positions). These extended sample values are used in gradient calculation only. For the remaining steps in the BDOF process, if any sample and gradient values outside of the CU boundaries are needed, they are padded (i.e., repeated) from their nearest neighbors.

### Decoder Side Motion Vector Refinement (DMVR)

In VVC, the accuracy of the MVs of the merge mode is increased using a bilateral-matching (BM) based decoder side motion vector refinement applied in bi-prediction. A refined MV is searched around the two initial MVs (MV0 and MV1) in the reference picture list L0 and reference picture list L1. The refined MVs are derived around the initiate MVs based on the minimum bilateral matching cost between the two reference blocks in L0 and L1.

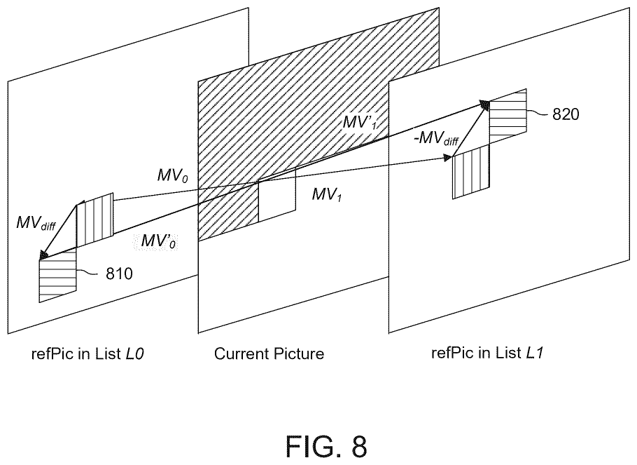

BM performs local search to derive integer sample precision intDeltaMV refinement symmetrically for predictions 0 and 1. As illustrated in FIG. 8, the SAD (Sum of Absolute Difference) between the blocks (810, 820) based on each MV candidate around the initial MV is calculated. The MV candidate with the lowest SAD becomes the refined MV and is used to generate the bi-predicted signal. In ECM, SAD is replaced with a cost function taking into account the refinement (intDeltaMv) around the initial MVs:

bilCost=mvDistanceCost+sadCost.

In ECM, in case of large CUs (size larger than 64), the SAD is replaced with MRSAD (Mean Removed SAD) applied to remove the DC effect of distortion between reference blocks.

In VVC, sub-pel refinement may be derived via interpolation in a parametric error surface based sub-pixel offset estimation. Using the position determined by the refined integer-pel MV as the center position, the center position cost and the costs at four neighboring positions from the center are used to fit a 2-D parabolic error surface equation.

In VVC, the application of DMVR is restricted and is only applied for the CUs which are coded with following modes and features (see DMVR conditions, 902):
CU (Coding Unit) level merge mode with bi-prediction MV
One reference picture is in the past and another reference picture is in the future with respect to the current picture. The distances (i.e., POC difference) from two reference pictures to the current picture are the same
Both reference pictures are short-term reference pictures
CU has more than 64 luma samples (not in ECM)
Both CU height and CU width are larger than or equal to 8 luma samples (not in ECM)
BCW (Bi-Prediction with CU-level Weights) weight index indicates equal weight (not in ECM)
WP (Weighted Prediction) is not enabled for the current block
CIIP (Enhanced Combined Inter-Intra Prediction) mode is not used for the current block

In ECM, DMVR is disabled with LIC. The decoder side motion vector refinement is carried out in three steps:
In the first pass, a refined MV is derived by applying BM to a coding block as depicted above (910),
In the second pass, a refined MV is derived by applying BM to a 16×16 grid subblock (915),
In the third step, the refined MV is derived by applying BDOF to an 8×8 grid subblock. For each 8×8 subblock, BDOF refinement is applied (930).

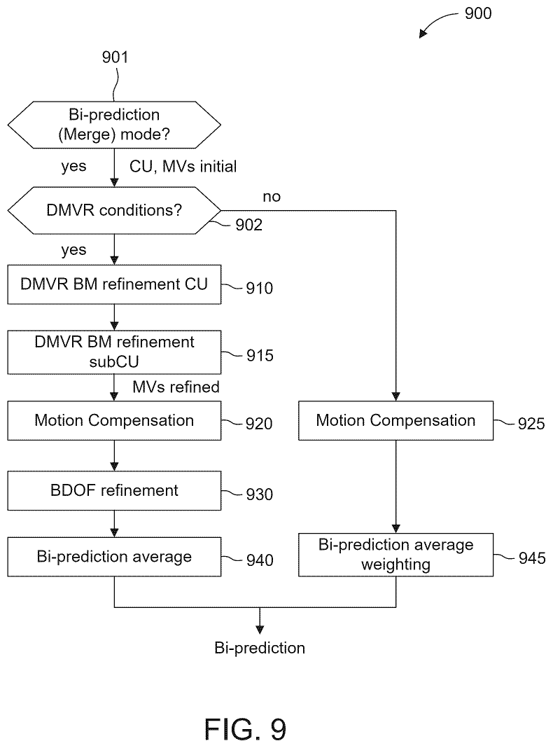

In particular, the overall process (900) of DMVR and BDOF in ECM is depicted in FIG. 9. When a CU uses a bi-predictive merge mode (901), the DMVR conditions described above are checked (902). If not respected, the CU is motion compensated (925) and BCW is applied (945). Otherwise, when DMVR conditions are satisfied, MVs are refined for the whole CU (910), then refined MVs are used to perform the sub-block refinement (915). The CU is motion compensated (920) with the sub-block refined MVs before the BDOF process is applied (930). The bi-predictive averaging (with equal weights) (940) is finally applied.

Some variants of DMVR may be based on simplifying process 900 by removing some steps such as step 915 or step 930.

### Spatial Optical Flow

Prediction Refinement with Optical Flow (PROF)

In JVET-N0236 (J. Luo and Y. He, CE2-Related: Prediction Refinement with Optical Flow for Affine Mode, Joint Video Experts Team (JVET), JVET-N0236, March 2019), an optical flow based motion refinement has been proposed to correct the block based affine motion compensation.

To achieve a finer granularity of motion compensation, JVET-N0236 proposes a method to refine the sub-block based affine motion compensated prediction with optical flow. After the sub-block based affine motion compensation is performed, luma prediction sample is refined by adding a difference derived by the optical flow equation. The proposed PROF is described as following four steps.
Step 1) The sub-block-based affine motion compensation is performed to generate sub-block prediction I(i, j).
Step 2) The spatial gradients

$$\frac{\partial I}{\partial x} ( i , j ) and \frac{\partial I}{\partial y} ( i , j )$$

of the sub-block prediction are calculated at each sample location using a 3-tap filter [−1, 0, 1].

$$\frac{\partial I}{\partial x} ( i , j ) = I ( i + 1 , j ) - I ( i - 1 , j )$$

$$\frac{\partial I}{\partial y} ( i , j ) = I ( i , j + 1 ) - I ( i , j - 1 )$$

### Equation 6: The Horizontal and Vertical Gradients of the Sub-Block Prediction Signal.

The sub-block prediction is extended by one pixel on each side for the gradient calculation. To reduce the memory bandwidth and complexity, the pixels on the extended borders are copied from the nearest integer pixel position in the reference picture. Therefore, additional interpolation for padding region is avoided.
Step 3) The luma prediction refinement is calculated by the optical flow equation.

$$Δ {I}_{P} ( x , y ) = \frac{\partial I}{\partial x} ( x , y ) * Δ {v}_{xP} ( x , y ) + \frac{\partial I}{\partial y} ( x , y ) * Δ {v}_{yP} ( x , y )$$

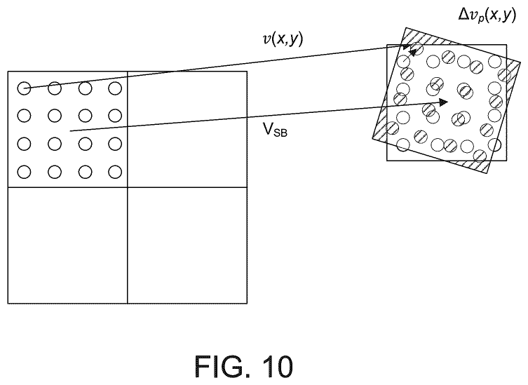

Equation 7: Adjustment with PROF for Each Sample in the 4×4 Sub-Block.
where Δv_{P}(x, y) is the difference between pixel-level MV computed for sample location (x, y), denoted by v(x, y), and the sub-block MV (V_{SB}) of the sub-block to which pixel (x, y) belongs, as shown in FIG. 10.

Since the affine model parameters and the pixel location relative to the sub-block center are not changed from sub-block to sub-block, Δv_{P}(x, y) can be calculated for the first sub-block, and reused for other sub-blocks in the same CU. Let x and y be the horizontal and vertical offset from the pixel location to the center of the sub-block, Δv_{P}(x, y) can be derived by the following equation,

$$\{ \begin{matrix}Δ {v}_{xP} ( x , y ) = c * x + d * y \\ Δ {v}_{yP} ( x , y ) = e * x + f * y\end{matrix}$$

Equation 8: Derive the Motion Vector Refinement (Δv_{xP}, Δv_{yP}).

For the 4-parameter affine model,

$$\{ \begin{matrix}c = f = \frac{{v}_{1 x} - {v}_{0 x}}{w} \\ e = - d = \frac{{v}_{1 y} - {v}_{0 y}}{w}\end{matrix}$$

For the 6-parameter affine model,

$$\{ \begin{matrix}\begin{matrix}\begin{matrix}c = \frac{{v}_{1 x} - {v}_{0 x}}{w} \\ d = \frac{{v}_{2 x} - {v}_{0 x}}{h}\end{matrix} \\ e = \frac{{v}_{1 y} - {v}_{0 y}}{w}\end{matrix} \\ f = \frac{{v}_{2 y} - {v}_{0 y}}{h}\end{matrix}$$

where (v₀ₓ, v_{0y}), (v₁ₓ, v_{1y}), (v₂ₓ, v_{2y}) are the top-left, top-right and bottom-left control point motion vectors, respectively, w and h are the width and height of the CU, respectively.
Step 4) Finally, the luma prediction refinement is added to the sub-block prediction I(i, j). The final prediction IP(x, y) is generated as the following equation.

I_{P}(x,y)=I(x,y)+ΔI_{P}(x,y)

Equation 9: Adjust the Prediction Samples with PROF.

The DMVR tool improves the bi-prediction coding performance significantly. In VVC and ECM it applies on block with a uniform translational motion model only. In this case, the process is simplified because the motion search around the initial motion vector can be performed using only one motion compensation.

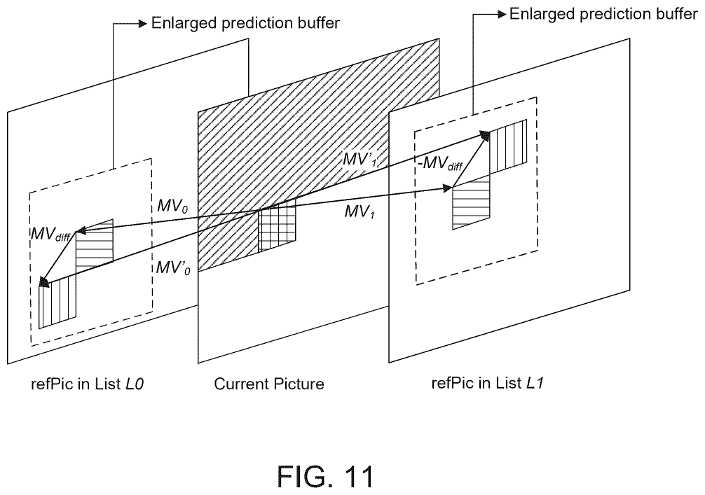

In particular, motion compensation using the initial motion is performed on an enlarged block as shown in FIG. 11, the computation of the SAD or MRSAD between the two predictions is then performed by reusing the cropped block inside this motion predicted blocks as the motion offset is integer only. Specifically, instead of doing MC (Motion Compensation) each time an integer difference is added to the MV, a single MC is performed for a larger area only for once, then we just shift (crop) the CU inside this larger area to retrieve the sample values corresponding to the adjusted MV to compute the SAD.

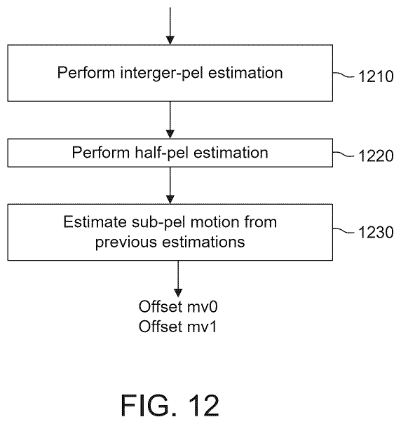

In FIG. 12, the overall process of DMVR is described. At step 1210, an integer-pel estimation of the best offsets is performed. At step 1220, refined half-pel of the best offsets is performed around the best integer-pel estimation of the previous step. At step 1230, refined sub-pel offsets are computed from the previously estimated score.

In some variant, the process can introduce more or fewer stages of refined offset estimation. In some variant, the process is repeated for subblocks of the block.

In recent work, the same process has been proposed for affine block. In order to keep the complexity low, a translation offset on top of the original affine model is used.

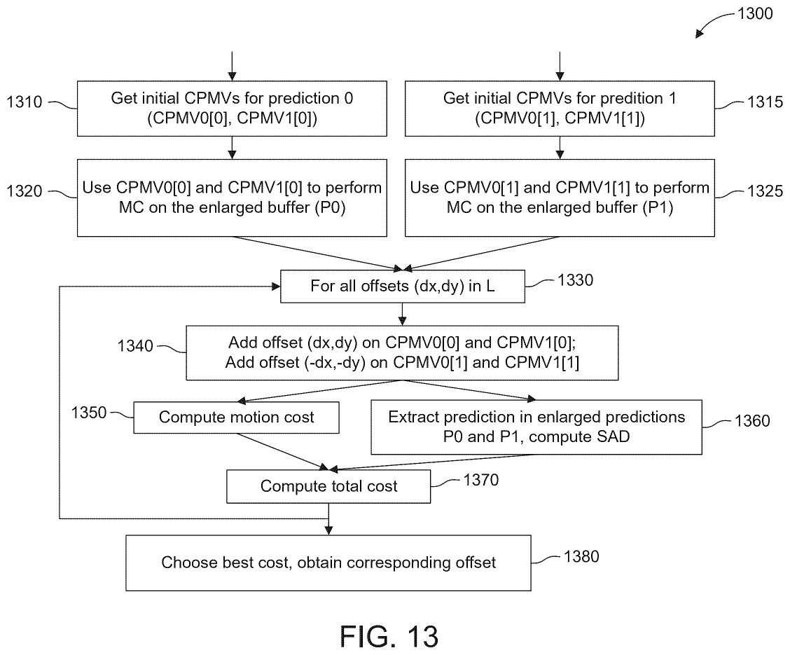

As an alternative, a full search refining the CPMV (Control Point of the Motion Vector) is used, leading to an increased complexity since a motion compensation is needed at each stage of the motion offset search. Without loss of generality, in the following examples, we use the 4-parameter affine model. As shown in FIG. 13, CPMV0[0] and CPMV1[0] are the two motion vector values (mvx, mvy) used for the 4-parameter affine model M0 associated with prediction 0, CPMV0[1] and CPMV1[1] are the two motion vector values (mvx, mvy) used for the 4-parameter affine model M1 associated with prediction 1.

FIG. 13 presents one round of the DMVR process for affine model. First the initial CPMVs found before DMVR are obtained (1310, 1315) with the affine models. The parameters for affine models M0 and M1, such as the four parameters in the 4-parameter affine model or the motion field for each sub-block, are derived with CPMV0[i] and CPMV1[i], i=0, 1. Enlarged affine motion compensation (MC) is performed, for example, at a sub-block level or sample level, using the initial affine model to generate each initial prediction P0 and P1 (1320, 1325).

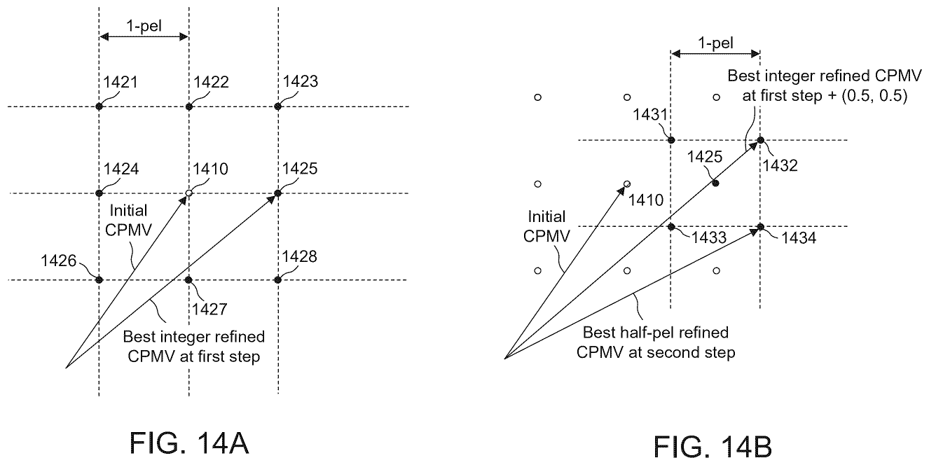

Then a loop on a list L of offsets (dx, dy) is performed (1330). For the first round, the list is typically a set of offsets of +1/−1 on each component, i.e., dx, and dy each can take values from {−1, 0, +1}, the list contains eight possible offsets ((−1, 0) (+1, 0) (0, −1) (0, +1) (−1, −1) (−1, +1) (+1, −1) (+1, +1)). As shown in FIG. 14A, the initial CPMV (1410) can be adjusted by eight possible offsets to test different CPMVs (1421-1428).

For each possible offset, (dx, dy), the CPMVs are adjusted accordingly (1340), i.e., offset (dx, dy) is added onto CPMV0[0] and CPMV1[0], and offset (−dx, −dy) is added onto CPMV0[1] and CPMV1[1]. In addition, new predictions can be extracted (1360) from the enlarged predictions. For example, for integer motion, we just shift the window by the offset (dx, dy) inside the affine MC buffer of prediction. A motion cost is calculated (1350) based on the value of the offset. A cost is then computed (1370) depending on the distortion between the two predictions and the motion cost.

The offset (dx_{best}, dy_{best}) associated with the best cost (e.g., the minimum cost) is used to update the CPMV of each model M0 and M1, i.e., CPMVi_{adjusted}[0]=CPMVi[0]+(dx_{best}, dy_{best}), CPMVi_{adjusted}[1]=CPMVi[1]−(dx_{best}, dy_{best}), i=0, 1. Then the updated/refined CPMVs are used in the final motion compensation to obtain the prediction, which will be used to be added to residue when reconstructing/decoding the block. These updated/refined CPMVs can be stored to be inherited by subsequent affine CUs.

In a second round, a displaced enlarged buffer ((dx, dy)=(0.5, 0.5)) is motion compensated depending on the best offset (the new buffer is created using (dx_{best}+0.5, dy_{best}+0.5)), in order to perform a half pixel refinement. In this case, at least 4 positions are examined (minimal SAD) to derive the half-pel precision best offset (e.g., (−1, 0), (−1, −1), (0, −1), (0, 0)). As shown in FIG. 14B, for the best integer refined CPMV (1425) at first step, four half-pel positions (1431-1434) are examined. In the example shown in FIG. 4B, the offset at position 1434 is selected as the best sub-pel offset.

Finally, an analytic offset is computed from the distortion of these four examined offsets in order to output a sub-pel precision offset.

In a variant, only one model (for example the model of the prediction 0) is updated with the offset, the second prediction being fixed.

In the above implementation, the complexity is still low since the motion compensation (MC) is done only once per round. However, the affine model is not completely refined, since only the translation component is updated as the same offset is used to adjust both CPMVs.

In the above example, the 4-parameter affine model is used. When a 6-parameter affine model is used, there would be three control point motion vectors for each of the affine model (M0, M1) and method 1300 can be adjusted accordingly. For example, at step 1310 (1315), CPMV0[0], CPMV1[0] and CPMV2[0] (CPMV0[1], CPMV1[1] and CPMV2[1]) would be initialized; at step 1340, the offset (dx, dy) would be used to adjust CPMV0[i], CPMV1[i] and CPMV2[i], i=0, 1.

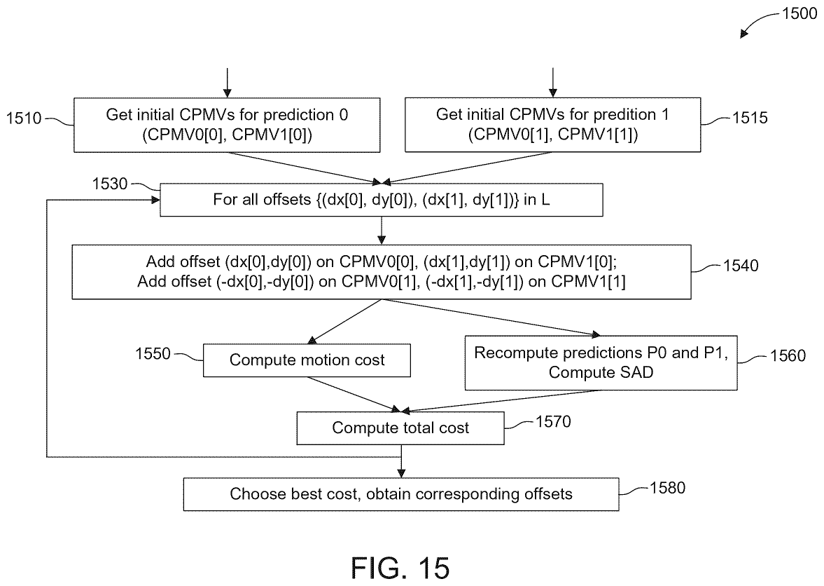

In FIG. 15, the whole model is refined, namely, different offsets on each CPMV are tested (1530). As shown in FIG. 15, after the CPMVs are initialized (1510, 1515) for predictions 0 and 1, separate offsets are used for different CPMVs (1540), e.g., offset (dx[0], dy[0]) is added onto CPMV0[0], (dx[1], dy[1]) is added onto CPMV1[0], offset (−dx[0], −dy[0]) is added onto CPMV0[1], (−dx[1], −dy[1]) onto CPMV1[1]. The motion cost is computed (1550), and the distortion (e.g., SAD) between predictions 0 and 1 is recomputed (1560) based on the adjusted CMPMs. For example, for each newly formed affine model, a motion compensation is performed using this model in order to produce the prediction. affine motion model is for example computed by computing the motion of each individual 4×4 sub-blocks based on the affine model of the block. A total cost is computed (1570) taking into consideration the distortion and the motion cost. After the best cost is obtained (1580), the offset {(dx[0]_{best}, dy[0]_{best}), (dx[1]_{best}, dy[1]_{best})} associated with the best cost is used to update the CPMV of each model M0 and M1, i.e.,

CPMV0_{adjusted}[0]=CPMV0[0]+(dx[0]_{best},dy[0]_{best}),

CPMV1_{adjusted}[0]=CPMV1[0]+(dx[1]_{best},dy[1]_{best}),

CPMV0_{adjusted}[1]=CPMV0[1]−(dx[0]_{best},dy[0]_{best}),

CPMV1_{adjusted}[1]=CPMV1[1]−(dx[1]_{best},dy[1]_{best}).

In this case, a motion compensation is necessary at each new set of offsets, which increases the complexity a lot. In a variant, the offsets are evaluated sequentially: first an offset is searched on the first CPMV, then the second CPMV is refined, etc. In a variant, the search is performed directly on the affine model parameters instead of the CPMVs. In all cases, a new motion compensation is needed at each test of refinement (1560).

When only one prediction is refined, the offsets are applied only on the CPMVs associated with this prediction.

In the above example, the 4-parameter affine model is used. When a 6-parameter affine model is used, there would be three control point motion vectors for each of the affine model (M0, M1) and method 1500 can be adjusted accordingly. For example, at step 1510 (1515), CPMV0[0], CPMV1[0] and CPMV2[0] (CPMV0[1], CPMV1[1] and CPMV2[1]) would be initialized; at step 1540, the offset (dx[i], dy[i]), i=0, 1, 2, would be used to adjust CPMV0[j], CPMV1[j] and CPMV2[j], j=0, 1.

The present embodiments are directed to simplify the search of the motion vector offset on each CPMV (or alternatively on the motion model parameters) by using only the initial motion compensation (like the DMVR in FIG. 13) and approximating the motion compensated prediction with motion offset by using a method similar to PROF.

### DMVR Motion Refinement on CPMV

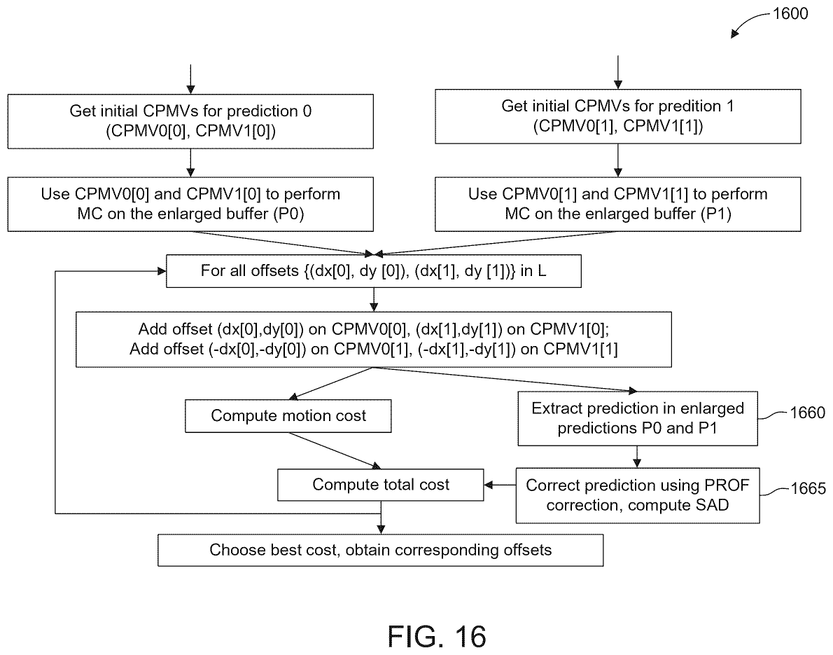

FIG. 16 illustrates a modified DMVR process (1600) for affine, according to an embodiment. It removes all the motion compensation stages needed to refine a whole affine model by using the regular enlarged prediction buffers associated with a process similar to PROF. The same modified DMVR process for affine can be applied at the encoder and decoder to refine the bi-prediction motion vectors. In the following, the differences of process 1600 from process 1500 are described in detail.

All CPMVs are tested with individual offsets, i.e., the whole affine model is refined (and not only the translation) for M0 and M1. Instead of computing a motion compensation for each new tested affine model, the closest predicted sample is extracted (1660) from the already computed enlarged prediction buffer.

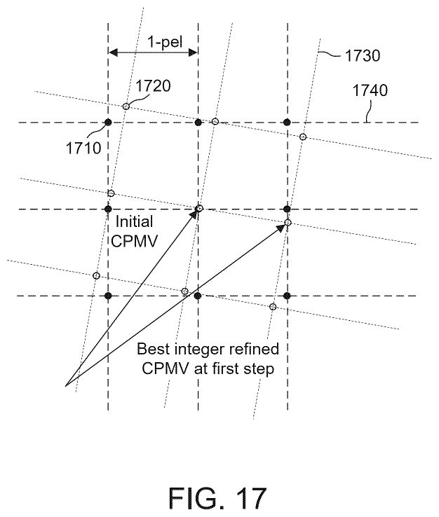

As shown in FIG. 17, grid 1740 is based on the initial CPMVs and grid 1730 is based on the adjusted CPMVs. Here, only rotation is introduced between grid 1740 and grid 1730. It should be noted that other motions, e.g., translation and zoom in/out may also exist.

In particular, FIG. 17 shows a part of a predicted CU, the enlarged pred P0 is shown in the horizontal/vertical grid. Grid 1740 is based on the initial CPMVs and grid 1730 is based on the adjusted CPMVs, by applying the affine model to each sub-blocks (or pixel in case of pixel-based affine). Here, only rotation is introduced between grid 1740 and grid 1730. It should be noted that other motions, e.g., translation and zoom in/out may also exist. Instead of recomputing a MC, for each sample in grid 1730, we choose the closest sample from the enlarged grid, i.e., choose the closest sample position from the translational only grid 1740. In particular, if the refined motion is less than 0.5 pixel, then the buffer with the initial MC is used as is and the PROF process is applied. If the CPMV moves more than 0.5 pixel (in translation), then the buffer is shifted accordingly to be at the closest position in integer pixel. For example, in FIG. 17, for sample position 1720 of a tested affine model, the sample value of sample position 1710 is used since sample position 1710 is closest to sample position 1720. More general, we can view the closest translational sample (round (dx), round (dy)) as a coarser version of the real sample.

The extracted prediction is then refined (1665) using a process similar to PROF, as described in further detail below. The refined predictions are used to compute (1665) the SAD (or MRSAD) score.

Alternatively, the motion refinement can be done sequentially on each CPMV of the block or sub-blocks. Alternatively, the motion refinement can be done by modifying the affine model parameters (offset applied on the model directly).

### Prediction Correction

In order to correct the motion compensated prediction (1665) extracted from the enlarged prediction buffer (1660), the following process is applied:
Step 1) The spatial gradients

$$\frac{\partial I}{\partial x} ( i , j ) and \frac{\partial I}{\partial y} ( i , j )$$

of the prediction I(i, j) are calculated at each sample location, for example using a 3-tap filter [−1, 0, 1] (other types of gradient filters can also be used, e.g., Sobel filter):

$$\frac{\partial I}{\partial x} ( i , j ) = I ( i + 1 , j ) - I ( i - 1 , j )$$

$$\frac{\partial I}{\partial y} ( i , j ) = I ( i , j + 1 ) - I ( i , j - 1 )$$

### Equation 10: The Horizontal and Vertical Gradients of the Sub-Block Prediction Signal.

For a pixel on the boundaries, the enlarged prediction is used to retrieve samples out of the current block for gradient computation without any additional complexity.
Step 2) The luma prediction refinement is calculated by the optical flow equation.

$$Δ {I}_{P} ( x , y ) = \frac{\partial I}{\partial x} ( x , y ) * Δ {v}_{xP} ( x , y ) + \frac{\partial I}{\partial y} ( x , y ) * Δ {v}_{yP} ( x , y )$$

### Equation 11: Adjustment for Each Sample

where Δv_{P}(x, y) is the difference between pixel-level MV v(x, y) computed for sample location (x, y) using the currently tested model and the MV v₀(x, y) used to compute the enlarged prediction P0 (or P1) to which pixel (x, y) belongs. Referring back to FIG. 17, v₀(x, y) is the MV from the motion field derived from CPMV0 and CPMV1, namely, the MV associated with grid 1740; v(x, y) is the MV from the motion field derived from CPMV0+(dx0, dy0) and CPMV1+ (dx1, dy1), namely, sample MVs associated with grid 1730,

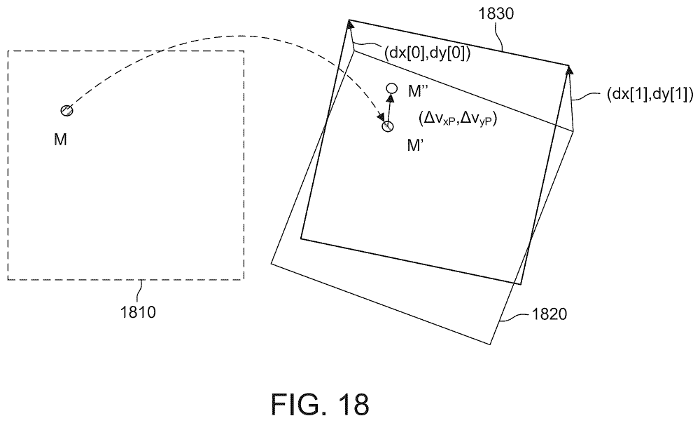

In FIG. 18, we illustrate v(x, y), v₀(x, y), and Δv_{P}(x, y) for a sample M inside a sub-block (1810) of an affine CU, M′ is a sample inside a sub-block (1820) of the predicted CU P0 based on the initial CPMVs, and M″ is a sample inside a sub-block (1830) of the predicted CU based on the adjusted CPMVs.

In FIG. 18, MV for M′ is computed using the initial affine model (or one after the first step of refinement) (1610, 1615). The MV can be computed sample wise, and to simplify the computation, the MV can be computed at the sub-block level. In case of 4×4 sub-block computation, the motion is the same for all pixels of the 4×4 sub-block, e.g., it is the motion at the center of the 4×4 sub-block. The new motion vector of M″ is computed using the tested affine model with displaced CPMVs (here displaced with offset (dx[0], dy[0]) and (dx[1], dy[1]) for CPMV0 and CPMV1, respectively). The motion is computed on a per sample basis (i.e., it assumes a PROF process would take place after the affine model refinement). Please note here the example is based on prediction P0, and the adjustment for prediction P1 is performed similarly.

In a variant, the motion is computed per sub-block 4×4 (at the center of the sub-block) and is used for all pixels of a 4×4 sub-block. Instead of estimating the motion for each sample (with the PROF process), only the center motion is estimated and applied to each sample in the sub-block to get their values.

From the computed motion, the motion difference between M′ and M″ is computed as (Δv_{xP}, Δv_{yP}). This difference is used in equation 11 to compute the illumination offset adjustment.

For an initial affine model defined as:

M′ₓ=a₀x+b₀y+c₀

M′_{y}=a′₀x+b′₀y+c′₀

where parameters a₀, a′₀, b₀, b′₀, c₀, c′₀ are deduced from the initial CPMV values and (x, y) are the pixel coordinate of pixel M.

The new tested model during the search displaced the point M as M″:

$${M}_{x}^{″} = {a}_{1} x + {b}_{1} y + {c}_{1}$$

$${M}_{y}^{″} = {a}_{1}^{′} x + {b}_{1}^{′} y + {c}_{1}^{′}$$

So that the motion differences are computed as:

Δv_{xP}=(a₁−a₀)x+(b₁−b₀)y+(c₁−c₀)

Δv_{yP}=(a′₁−a′₀)x+(b′₁−b′₀)y+(c′₁−c′₀)

The coefficients in front of x and y need to be computed only once per affine model tested (as the resulting difference of the two affine models is also an affine model). Advantageously, the motion difference can be computed sequentially for each pixel by adding the correct offset.

For the first pixel on top-left corner:

Δv_{xP}(x,y)=(a₁−a₀)x+(b₁−b₀)y+(c₁−c₀)

Δv_{yP}(x,y)=(a′₁−a′₀)x+(b′₁−b′₀)y+(c′₁−c′₀)

For the pixel on the left (i.e., at (x+1, y)):

Δv_{xP}(x+1,y)=Δvₓ(x,y)+(a₁−a₀)

Δv_{yP}(x+1,y)=Δv_{y}(x,y)+(a′₁−a′₀)

For the pixel below (i.e., at (x, y+1)):

Δv_{xP}(x,y+1)=Δvₓ(x,y)+(b₁−b₀)

Δv_{yP}(x,y+1)=Δv_{y}(x,y)+(b′₁−b′₀)

The process can be iterated to compute each motion difference only using offsets from neighboring motion difference.

Furthermore, depending on the offset tested per CPMV, the above offset computation can be further simplified. For CPMV0[0] and CPMV1[0], written as (v₀ₓ, v_{0y}) (v₁ₓ, v_{1y}), and after CPMV0[0] is adjusted by offset (+1, 0), written as (v₀ₓ+1, v_{0y}) (v₁ₓ, v_{1y}), the affine model can be expressed as

$$\{ \begin{matrix}{v}_{x} = \frac{{v}_{1 x} - {v}_{0 x}}{W} x + \frac{{v}_{0 y} - {v}_{1 y}}{W} y + {v}_{0 x} = {a}_{0} x + {b}_{0} y + {c}_{0} \\ {v}_{y} = \frac{{v}_{1 y} - {v}_{0 y}}{W} x + \frac{{v}_{1 x} - {v}_{0 x}}{W} y + {v}_{0 y} = {a}_{0}^{′} x + {b}_{0}^{′} y + {c}_{0}^{′}\end{matrix}$$

$$\{ \begin{matrix}{v}_{x}^{′} = \frac{{v}_{1 x} - ( {v}_{0 x} + 1 )}{W} x + \frac{{v}_{0 y} - {v}_{1 y}}{W} y + {v}_{0 x} + 1 = {a}_{1} x + {b}_{1} y + {c}_{1} \\ {v}_{y}^{′} = \frac{{v}_{1 y} - {v}_{0 y}}{W} x + \frac{{v}_{1 x} - ( {v}_{0 x} + 1 )}{W} y + {v}_{0 y} = {a}_{1}^{′} x + {b}_{1}^{′} y + {c}_{1}^{′}\end{matrix}$$

Therefore:

$${b}_{1}^{′} - {b}_{0}^{′} = 0$$

$${a}_{1}^{′} - {a}_{0}^{′} = 0$$

$${c}_{1}^{′} - {c}_{0}^{′} = 0$$

Step 3) Finally, the luma prediction refinement is added to the sub-block prediction I(i, j). The final prediction I_{P}(x, y) is generated as the following equation.

I_{P}(x,y)=I(x,y)+ΔI_{P}(x,y)

Equation 12: Adjust the Prediction Samples with PROF.

In the above example, the 4-parameter affine model is used. When a 6-parameter affine model is used, there would be three control point motion vectors for each of the affine model (M0, M1) and method 1600 can be adjusted accordingly. For example, at step 1610 (1615), CPMV0[0], CPMV1[0] and CPMV2[0] (CPMV0[1], CPMV1[1] and CPMV2[1]) would be initialized; at step 1640, the offset (dx[i], dy[i]), i=0, 1, 2, would be used to adjust CPMV0[j], CPMV1[j] and CPMV2[j], j=0, 1.

In the above, we discuss motion model parameters for bi-prediction where the refinement is performed symmetrically on both references. More generally, the motion model parameters can be adjusted for just one reference (from reference list 0 or 1), namely, the CPMVs are only adjusted for one reference, but the CPMVs for the other reference are not adjusted.

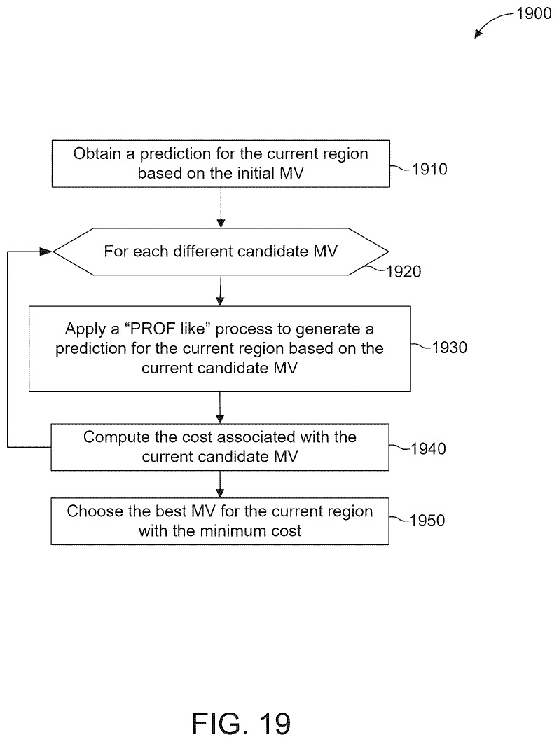

The described process is also applied when the initial motion model is not affine. For example, an affine motion model is initialized only with the translation of the block. It is then refined using the described process. In particular, for a translational CU there is only one MV (as the initial model parameter), but it is the same as an affine CU with both CPMV equal to this MV. By doing so and with the proposed refinement, it is possible to transform a translational CU into a real affine one. In general, the proposed methods can be applied to different motion models. In particular, we can use a “PROF like” process to generate several predictions from a prepared MC buffer, then cropping is done at sample accuracy and prediction is generated by correcting each sample using the motion difference and some spatial gradients. While the process is mainly described above with respect to DMVR, the proposed methods can be applied to different processes when the best motion is to be selected from multiple motion candidates as illustrated in FIG. 19.

In particular, the encoder or decoder performs motion compensation to obtain (1910) a prediction for the current region based on an initial MV. Then for each other possible candidate MV (1920), motion compensation is not performed. Instead, the encoder or decoder applies (1930) a “PROF like” process to generate a prediction for the current region based on the current candidate MV, and computes (1940) the cost associated with the current candidate MV.

Then the encoder or decoder chooses (1950) the best MV for the current region with the minimum cost.

Here the initial MV and candidate MVs may be based on the same type of motion model, for example, 4-parameter or 6-parameter affine models, but with different control parameters. The initial MV and candidate MVs can also be based on different types of motion modes, for example, the initial MV can be translational, and the candidate MVs use the affine model. The region can be a 4×4 sub-block or of other sizes.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the inter prediction modules (270, 375), of a video encoder 200 and decoder 300 as shown in FIG. 2 and FIG. 3. Moreover, the present aspects are not limited to ECM, VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of video encoding, comprising:
obtaining a first set of motion vectors for a plurality of samples in a region of a picture;
obtaining a first prediction for said region based on said first set of motion vectors for said region;
obtaining a second set of motion vectors for said plurality of samples in said region;
forming a second prediction for said region based on said first prediction;
adjusting said second prediction for said region based on optical flow, using at least a motion difference between said first set of motion vectors and said second set of motion vectors and using spatial gradients of said plurality of samples in said region;
selecting a prediction from at least said first prediction and second prediction; and
encoding said region based on said selected prediction.

2. (canceled)

3. The method of claim 1, wherein said first set of motion vectors for said region is based on a first set of parameters associated with a motion model, and wherein said second set of motion vectors for said region is based on a second set of parameters associated with said motion model.

4. (canceled)

5. The method of claim 3, wherein said first set of parameters correspond to a first set of control point motion vectors, and wherein said second set of parameters correspond to a second set of control point motion vectors.

6-8. (canceled)

9. An apparatus for video encoding, comprising at least a memory and one or more processors, wherein said one or more processors are configured to:
obtain a first set of motion vectors for a plurality of samples in a region of a picture;
obtain a first prediction for said region based on said first set of motion vectors for said region;
obtain a second set of motion vectors for said plurality of samples in said region;
form a second prediction for said region based on said first prediction;
adjust said second prediction for said region based on optical flow, using at least a motion difference between said first set of motion vectors and said second set of motion vectors and using spatial gradients of said plurality of samples in said region;
select a prediction from at least said first prediction and second prediction; and
encode said region based on said selected prediction.

10. (canceled)

11. The apparatus of claim 9, wherein said first set of motion vectors for said region is based on a first set of parameters associated with a motion model, and wherein said second set of motion vectors for said region is based on a second set of parameters associated with said motion model.

12. (canceled)

13. The apparatus of claim 11, wherein said first set of parameters correspond to a first set of control point motion vectors, and wherein said second set of parameters correspond to a second set of control point motion vectors.

14-18. (canceled)

19. A method of video decoding, comprising:
obtaining a first set of motion vectors for a plurality of samples in a region of a picture;
obtaining a first prediction for said region based on said first set of motion vectors for said region;
obtaining a second set of motion vectors for said plurality of samples in said region;
forming a second prediction for said region based on said first prediction;
adjusting said second prediction for said region based on optical flow, using at least a motion difference between said first set of motion vectors and said second set of motion vectors and using spatial gradients of said plurality of samples in said region;
selecting a prediction from at least said first prediction and second prediction; and
decoding said region based on said selected prediction.

20. The method of claim 19, wherein said first set of motion vectors for said region is based on a first set of parameters associated with a motion model, and wherein said second set of motion vectors for said region is based on a second set of parameters associated with said motion model.

21. The method of claim 20, wherein said motion model is an affine motion model.

22. The method of claim 20, wherein said first set of parameters correspond to a first set of control point motion vectors, and wherein said second set of parameters correspond to a second set of control point motion vectors.

23. The method of claim 19, wherein said first set of motion vectors is translational, and said second set of motion vectors is based on an affine motion model.

24. The method of claim 19, wherein said forming a second prediction for said region based on said first prediction comprises:
using a closest sample in said first prediction for said region as a sample in said second prediction for said region.

25. The method of claim 19, further comprising:
obtaining a first motion vector difference for a first sample in said region; and
obtaining another motion vector difference for a second sample in said region by adding said first motion vector difference for said first sample and a constant offset, wherein said second sample is to the left of or below said first sample.

26. An apparatus for video decoding, comprising at least a memory and one or more processors, wherein said one or more processors are configured to:
obtain a first set of motion vectors for a plurality of samples in a region of a picture;
obtain a first prediction for said region based on said first set of motion vectors for said region;
obtain a second set of motion vectors for said plurality of samples in said region;
form a second prediction for said region based on said first prediction;
adjust said second prediction for said region based on optical flow, using at least a motion difference between said first set of motion vectors and said second set of motion vectors and using spatial gradients of said plurality of samples in said region;
select a prediction from at least said first prediction and second prediction; and
decode said region based on said selected prediction.

27. The apparatus of claim 26, wherein said first set of motion vectors for said region is based on a first set of parameters associated with a motion model, and wherein said second set of motion vectors for said region is based on a second set of parameters associated with said motion model.

28. The apparatus of claim 27, wherein said motion model is an affine motion model.

29. The apparatus of claim 27, wherein said first set of parameters correspond to a first set of control point motion vectors, and wherein said second set of parameters correspond to a second set of control point motion vectors.

30. The apparatus of claim 26, wherein said first set of motion vectors is translational, and said second set of motion vectors is based on an affine motion model.

31. The apparatus of claim 26, wherein said one or more processors are configured to form a second prediction for said region based on said first prediction by performing:
using a closest sample in said first prediction for said region as a sample in said second prediction for said region.

32. The apparatus of claim 26, wherein said one or more processors are further configured to:
obtain a first motion vector difference for a first sample in said region; and
obtain another motion vector difference for a second sample in said region by adding said first motion vector difference for said first sample and a constant offset, wherein said second sample is to the left of or below said first sample.
